(19) United States
(12) Patent Application Publication
(10) Pub. No.: US 2025/0259429 A1
(43) Pub. Date: Aug. 14, 2025

(54) Associating a target class with an object

(71) Applicant: SICK AG, Waldkirch (DE)

(72) Inventors: Dominic MAI, Waldkirch (DE); Oliver WEBER, Waldkirch (DE)

(21) Appl. No.: 19/052,722

(22) Filed: Feb. 13, 2025

(30) Foreign Application Priority Data
Feb. 14, 2024 (EP) 24157543.0

(51) Int. Cl. G06V 10/776; G06V 10/764; G06V 10/82

(52) U.S. Cl. CPC G06V 10/776; G06V 10/764; G06V 10/82; G06V 2201/06

(57) ABSTRACT

An image capturing device (10) for associating a target class with an object (14) is provided, wherein the image capturing device (10) has an image sensor (20) for recording image data having the object (14) and a control and evaluation unit (22) that is configured to evaluate and classify the image data using a method of machine learning, in particular a neural network, and to associate a target class with the image data. In this respect, the control and evaluation unit (22) is further configured to use as a method of machine learning a multiclass classifier for the classification into a plurality of intermediate classes that determines respective confidence values for the association of the image data with a respective intermediate class and subsequently to determine the target class by applying a map of confidence values in target classes.

The invention relates to an image capturing device and to a method for associating a target class with an object.

It is necessary to recognize objects or their properties in a large number of image processing applications, in particular in logistics or automation. In addition to classical methods, those of machine learning or of artificial intelligence have also long been used for the classification of image data or of objects recorded therein. Since the path-blazing publication of AlexNet in Krizhevsky, Alex, Ilya Sutskever, and Geoffrey E. Hinton, “Imagenet classification with deep convolutional neural networks”, Advances in neural information processing systems 25 (2012), this field has indisputably practically been dominated by deep neural networks (deep learning). However, there have been substantial further developments here in the meantime.

One variety of classification is so-called multi-label classification. In this respect, a plurality of properties or classes are assigned to an object. Multiclass classification is used for this in the following even though strictly speaking this is basically only the opposite of binary classification. The paper by Read, Jesse, and Fernando Perez-Cruz, “Deep learning for multi-label classification”, arXiv preprint arXiv: 1502.05988 (2014), for example, deals with multiclass classification in the just defined sense.

Ridnik, Tal, et al, “ML-decoder: Scalable and versatile classification head”, Proceedings of the IEEE/CVF Winter Conference on Applications of Computer Vision, 2023, describes a particularly powerful multiclass classification. An attention mechanism is used here such as is known from transformer architecture, with an only linear effort being achieved by an adaptation (dispensing with the self-attention layer). The ML-Decoder is intended as a supplementary classification head which is preceded by a pre-processing with a further neural network such as ResNet or TResNet, see Ridnik, Tal, et al. “Tresnet: High performance gpu-dedicated architecture”, proceedings of the IEEE/CVF winter conference on applications of computer vision, 2021, on the latter. An alternative to this is MobileViT from the paper Mehta, Sachin, and Mohammad Rastegari, “Separable self-attention for mobile vision transformers”, arXiv preprint arXiv: 2206.02680 (2022). It must finally be mentioned that an asymmetrical loss evaluation (loss function) can be helpful in multiclass classification, cf. Ridnik, Tal, et al. “Asymmetric loss for multi-label classification”, Proceedings of the IEEE/CVF International Conference on Computer Vision, 2021.

In practice, the training of a neural network for a specific classification task represents a challenge since a huge effort has to be expended for it. This is particularly problematic if the class definition changes over time. Such adaptations have to date only been possible by a repeat training or at least extensive retraining.

It is therefore the object of the invention to further improve the association of a class with image data.

This object is satisfied by an image capturing deice and by a method for associating a target class with an object respectively. The target class is the actual result of the classification and is called this, to delineate it form the immediately introduced intermediate classes, since the classification in accordance with the invention takes place in two stages. Image data having the object to be classified are recorded by an image sensor. A control and evaluation unit evaluates the image data to associate the target class and a method of machine learning, in particular a neural network, is implemented therein for this purpose. A control and evaluation unit is at least one arbitrary hardware component that may be provided internally in the image capturing device and/or may be connected thereto and that provides the required processing and memory capacities.

The invention starts from the basic idea of first determining intermediate classes using a multiclass classifier. The result of this intermediate step represents confidence values that indicate how reliably a respective intermediate class can be associated with the image data. In this respect, multiple associations in a plurality of or even in all the intermediate classes are explicitly desired. A digital, improper confidence value is conceivable that therefore determines whether an intermediate class has been associated or not by Yes/No information. However, quantitative confidence values are preferred, for example at an interval [0,1], that can always be achieved by a simple rescaling. The multiclass classifier works with a method of machine learning.

An association in at least one target class, preferably exactly one target class, subsequently takes place using the intermediate classes. A map of the confidence values of the intermediate class in the target class serves this purpose. This map is thus a function or an association rule that associates one or more target classes with a tuple of confidence values. The tuple preferably has so many elements as there are intermediate classes; any dimensional difference from a tuple having a different number of elements can anyway be returned to this case by filling up with zeroes or a projection mapping. Intermediate classes and target classes are not identical with one anther; there is therefore at least one target class that is not found among the intermediate classes. The mapping prepares the target classes from the intermediate classes while taking account of predefined rules in a very illustrative and simplifying manner.

The method of machine learning is thus trained for the intermediate classes and not for the target classes. The latter would be conceivable in practice, but is actually avoided in accordance with the invention to be able to dispense with a complex (re-) training on a change of the target classes. The mapping subsequent to the multiclass classification preferably does not require any training, but is rather the result of a comparatively simple optimization. It remains conceivable likewise to use a method of machine learning, in particular a second neural network, for this purpose. The effort for its training is very small since only the intermediate classes, that are very few in comparison with the pixels of an image, have to be considered as input data. The mapping is, however, preferably a simple, deterministic association rule or a simple algorithm parameterized according to the rules of the target classes without methods of machine learning or a neural network.

The invention has the advantage that target classes can be very simply associated with image data or objects recorded therein that are in particular predefined for an application in logistics or automation. Change desires for adaptation to new challenges can be considered thanks to the optimized mapping of intermediate classes. The most complex step, namely the training of the multiclass classifier, does not have to be repeated for this.

None of the target classes is preferably an intermediate class. It has already been mentioned that intermediate classes and target classes are not identical overall; the mapping would then be superfluous or could be implemented by extremely simple rules such as the identity or a projection. In accordance with this embodiment, target classes and intermediate classes should further even be disjunctive. Every target class thus depends on more than one intermediate class; the target classes are mixtures of the intermediate classes and the linking connecting mixing rule is the mapping.

The intermediate classes are preferably defined by at least one of the following properties of the recorded object: Material, in particular plastic, polystyrene, wood, or metal; strength, in particular rigid or flexible, i.e. the material tensile strength respectively solidity/consistency; or shape, in particular parallelepiped, cylinder, torus, or irregular. These are only some examples of possible intermediate classes; the multiclass classifier can be trained for any desired intermediate classes. Further conceivable intermediate classes relate to the color, the reflection, or the size, provided that there is a standard of comparison, for example by a fixed recording situation.

Exactly two target classes are preferably provided, in particular cardboard or not cardboard. Whereas there is a large number of intermediate classes, only one of two target classes is associated binarily in the final effect according to this embodiment. An example is the distinction relevant to logistical applications whether the object is cardboard or not. In an embodiment, the property cardboard is fully derived from other properties of the intermediate classes. However, even if there is an intermediate class for cardboard as an external packaging material, the target class for this can differ due to further rules, for instance because a box surrounded by plastic strips or a plastic sleeve should actually no longer fit in the target class. Such additional conditions can be detected in the mapping of intermediate classes into target classes.

The multiclass classifier preferably has an attention mechanism. This makes possible a particularly powerful association with intermediate classes.

The multiclass classifier preferably has a first stage that generates an embedding from the image data and a second stage that determines the intermediate classes from the features of the embedding. In the first stage (backbone), features are extracted, in particular in the form of an embedding, that are then used by a classification head to determine the intermediate stage. Such an architecture, for example with TResNet or MobileViT as the backbone and the ML-Decoder as the classification head, is particularly well suited to reliably determine the intermediate classes.

The mapping preferably evaluates the intermediate classes individually using a threshold value. In the general case, the mapping is any desired function of an m-dimensional space into an n-dimensional space with m intermediate classes and n target classes. In this embodiment, the space of the possible mappings is considerably cut in that each of the m intermediate classes is first evaluated per se by a threshold. This then produces an equivalent to an m-digit binary word so that a respective target class only has to be associated with these binary words. The mapping required for the locating of the map is thus dramatically simplified. It is not even necessary to differentiate all the m-digit binary words. It can, for example, be sufficient for the decision “cardboard” that the intermediate class “wood” or “plastic” is above the threshold; the map should then associate “not cardboard”. The map simplified to threshold values has the additional advantage that such thresholds are intuitively understandable for the user. There are therefore interpretable intermediate classes or evaluations of the influence of the intermediate classes on the target classes. Contrary to this, intermediate results or feature maps from a conventional training of a method of machine learning are usually non-transparent and not understandable for the user (blackbox). The interpretability in particular makes a very simple subsequent adaptation by the user possible. It is possible, for example, that a parcel should no longer be classified in the target class cardboard with only a small plastic portion. The map is, however, initially parameterized such that a parcel having only a small confidence value for plastic is still associated with the target class cardboard. An engineer on site can now simply adapt the threshold value for plastic so that the parcel as desired is no longer classified as cardboard due to the plastic portion. This is done by a simple reset of a parameter and requires neither subsequent training of the multiclass classifier nor a repeat optimization of the map.

The map is preferably taught in that the multiclass classifier determines confidence values for a plurality of example images annotated by a desired target class and that map is determined in an optimization that best reproduces the associated annotated target class with a predetermination of the respective confidence values found with respect to an example image. The desired rules for the target classes are thus specified in the form of example images and of the target class resulting from the rules for the respective example image, for instance in a manual labeling process in which a human observer annotates example images following the rules. The source of the annotated example images is of no interest for the invention. If an example image annotated in this manner is evaluated by the multiclass classifier, the intermediate classes and, from the label of the example image, the target classes matching them are subsequently known. A plurality of tuples of the kind ((intermediate class_1, . . . , intermediate class_m), (target class_1), . . . , target class_n)) result on processing a plurality of example images and the map that reproduces this plurality of tuples as largely as possible can be determined from this, for example by means of a function fit or another optimization process. A further method of machine learning, in particular a second neural network, would be conceivable instead of a function fit. Its training is no longer based on the flood of data of the original image data, but only on the plurality of said tuples and is thus not laborious.

The map is preferably initialized using initially arbitrary threshold values for every intermediate class and the optimization only changes the threshold values. This corresponds with the above-discussed simplified map that evaluates intermediate classes individually with a threshold value. A global optimum is possibly not found with this, but a map that works sufficiently well; with the advantage of a very considerably simplified optimization problem.

The image capturing device is preferably installed at a conveying device on which objects to be classified are conveyed through the field of view of the image sensor, with in particular a plurality of camera heads being provided and the control and evaluation unit being configured to merge the recordings of the camera heads in the image data to one common image. The conveying device is, for example, part of a production line or sorting plant of the automation or logistics industry and it moves objects consecutively into the detection zone. In some cases the visual range of an individual camera is too small for the objects or the conveying device. An image capturing device having two or more cameras heads whose image data can be merged (stitching) can then be used.

The method in accordance with the invention is a computer implemented process that runs, for example, on a camera or on another processing unit, either in real time in a processing unit at least indirectly connected to the camera or with a time offset in any desired processing unit.

The map is preferably taught in that the multiclass classifier determines confidence values for a plurality of example images annotated by a desired target class and that map is determined in an optimization that best reproduces the associated annotated target class with a predetermination of the respective confidence values found with respect to an example image. This corresponds to the procedure already explained above. The multiclass classifier is trained beforehand, for example in a supervised learning using example images annotated by intermediate classes. The training of the multiclass classifier is a step to be distinguished from the determination of the map. It can take place at a completely different location, at a different time, on a different unit and uses different example images, or at least a different training dataset in which at least one separate annotation has been performed, namely with intermediate classes and not target classes. As emphasized multiple times, the multiclass classifier is not again trained for or retrained for target classes after the training for the intermediate classes; the map from the intermediate classes of the multiclass classifier performs the determination of target classes.

The method in accordance with the invention can be further developed in another respect in a similar manner as the image capturing device and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

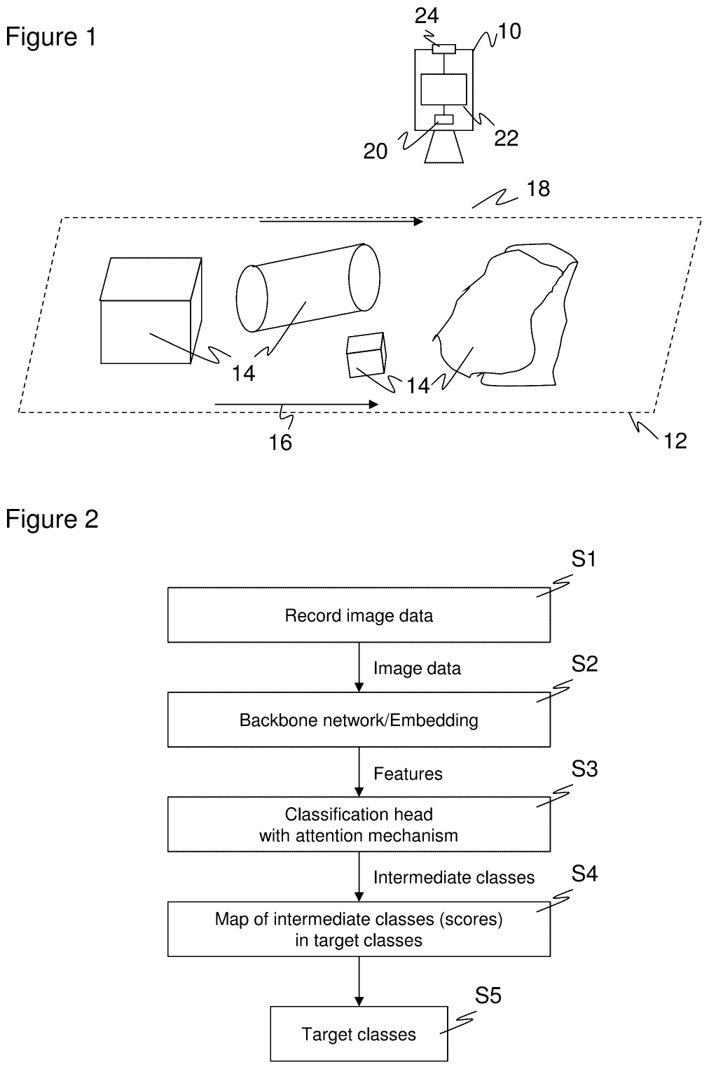

FIG. 1 an overview representation with a camera for classifying objects that are conveyed through the field of view of the camera on a conveyor belt;

FIG. 2 an exemplary flowchart for classifying first in intermediate classes and then mapping the intermediate classes to a target class;

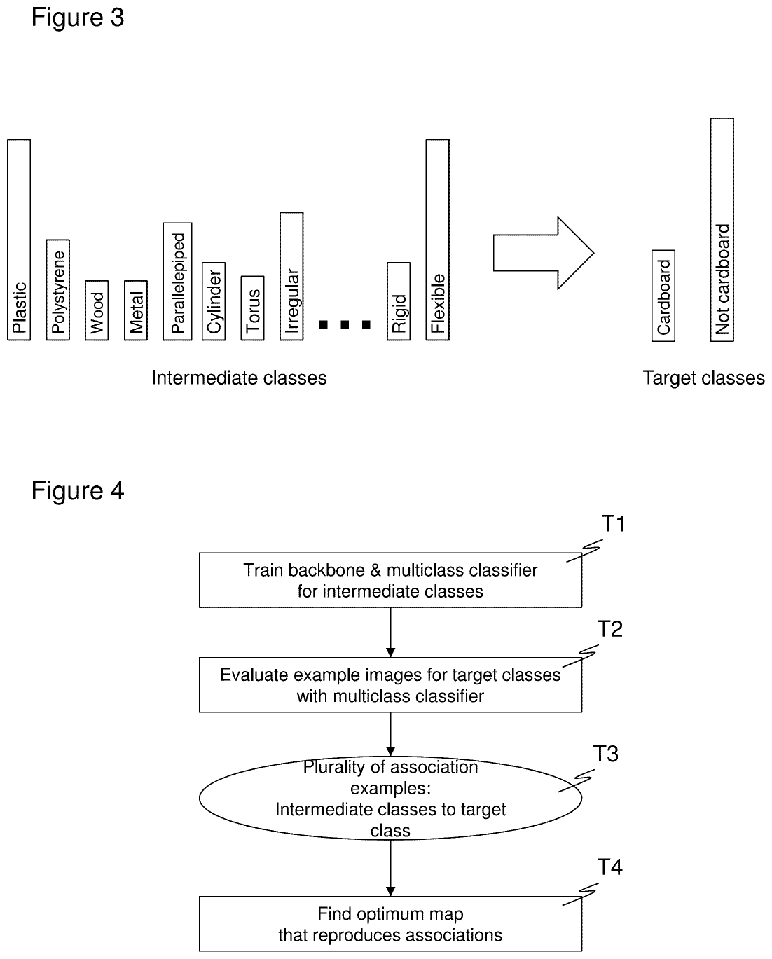

FIG. 3 an illustration of the map from intermediate classes to target classes; and

FIG. 4 an exemplary flowchart for training the multiclass classifier for the classification into intermediate classes and for locating the map of intermediate classes to target classes.

FIG. 1 shows a camera 10 which is mounted above a conveyor belt 12 which conveys objects 14 through the detection zone 18 of the camera 10, as indicated by the arrow 16. The stationary installation of a camera 10 at a conveyor belt is an application that occurs frequently in practice; for instance, for logistics or automation work or for quality control. The invention, however, relates to the classifying of images or of the objects 14 recorded thereby, in particular with the purpose of initiating downstream processing steps in dependence on the classification such as the sorting, demanding a manual post-processing, and the like. The example must therefore not be understood as restrictive; an object 14 can also be presented to the camera 10 in another way. The objects 14 in FIG. 1 differ due to the representation only by their shapes; the classification can naturally also relate to different properties.

The camera 10 detects image data of the conveyed objects 14, that are further processed by a control and evaluation unit 22 using an image sensor 20. The control and evaluation unit 22 comprises, for example, at least one processing module such as a microprocessor or a CPU (central processing unit), an FPGA (field programmable gate array), a DSP (digital signal processor), an ASIC (application specific integrated circuit), an Al processor, an NPU (neural processing unit), a GPU (graphics processing unit), a VPU (video processing unit), or the like. The control and evaluation unit 22 is shown as an internal processing module. Alternatively, there can be a plurality of processing modules that may at least partly also be arranged external to the camera 10. An external processing unit can be a computer of any desired kind, including notebooks, smartphones, tablets or controllers, equally a local network, an edge device, or a cloud. The control and evaluation unit 22 that is responsible for the classification or for the interference can furthermore comprise completely different hardware than that on which the classification is trained, taught, or parameterized.

It is not the specific imaging process that is furthermore important for the invention so that the camera 10 can be set up in accordance with any principle known per se. For example, only one respective line is detected and the control and evaluation unit assembles the lines detected in the course of the conveying movement to the image data. A larger zone can already be detected in a recording fusing a matrix-like image sensor 20, with the assembly of recordings here also being possible both in the conveying direction and transversely thereto. Such multiple recordings can also be recorded simultaneously or overlapping in time using a camera 10 that in contrast to FIG. 1 has a plurality of camera heads. The camera 10 can output information over an interface 24 such as image data or classification results determined with respect to the image data or the recorded objects 14.

FIG. 2 shows an exemplary flowchart for classifying image data or objects 14 recorded therein. Image data are recorded in a step S1. Features with respect to the image data are generated in a backbone network in a step S2. TResNet or MobileViT or MobileVTv2 can be used as the backbone network, for example. It may be advantageous with a multiclass classification to use an asymmetrical loss function (loss function).

The features of the backbone network are supplied to a classification head that uses an attention mechanism in a step S3. The classification head replaces (“drop-in replacement”) a pooling (GAP, global average pooling) that is alternatively usable or also still usable. The attention mechanism, that has in particular acquired further prominence due to the transformer architecture, produces better results by taking contexts into account. The ML-Decoder from the literature cited in the introduction is particularly suitable and reference is also additionally also made thereto with respect to details with regard to the backbone and the asymmetrical loss function. The attention mechanism of the transformer is converted in an ML-Decoder in favor of a smaller effort; reference is also made to the literature in this regard.

Intermediate classes and associated confidence values (scoring) can be output for the intermediate classes as a result of the classification. The two-part procedure using a backbone and a subsequent classification head in steps S2 and S3 is a preferred embodiment of a multiclass classifier with a particularly modern, powerful architecture. Different classifications are, however, also possible in a divergent manner as long as the intermediate classes with confidence values are produced as the result.

The intermediate classes determined by the multiclass classifier of steps S2 and S3 are not yet the desired result of the classification so that they also bear the name intermediate classes. The actual target class is now determined from the intermediate classes and their confidence values in a step S4. This is done by a simple association rule or map that is illustrated in FIG. 3. Some exemplary intermediate classes are shown on the left side there. They relate, for example, to material, shape, and strength, with the invention, however, also managing with any other, also very much finer intermediate class definitions, that is, is neither restricted to these categories nor to the specific examples of plastic, polystyrene, wood, metal, parallelepiped, cylinder, torus, irregular, rigid, or flexible. The height of the bars symbolizes how clearly this intermediate class has been found by the multiclass classifier, that is, it illustrates the confidence value. It is here expressly permitted that a plurality of intermediate classes are simultaneously very pronounced, i.e. are recognized with a high confidence value.

The map symbolized by the arrow assigns at least one target class to the confidence values of the intermediate classes. The map takes account of the distribution of the confidence values over the intermediate classes by the association rule defined in the map to assign specific target classes. In a preferred embodiment, there is only one respective target class; but in the final result of the target classes analogous to the intermediate classes a multiple classification is conceivable; the map is then correspondingly multidimensional, not only in its definition range, but also in its value range.

The target classes are then determined in a step S5. In the illustrated example of FIG. 3, the map first produces not only a target class, but rather again confidence values now for the target classes. The number of target classes can still be reduced, in particular to only one target class, by a threshold evaluation or a determination of the maximum value. As already mentioned, the map can also directly only produce one single target class, with or without a confidence value. In the example, the intermediate classes plastic and irregular are greatly represented and accordingly under the target classes, that are binary here, cardboard/not cardboard, the latter is indicated.

FIG. 4 shows an exemplary flowchart for training the multiclass classifier for the classification into intermediate classes and for locating the map of intermediate classes to target classes. The multiclass classifier is trained in a step T1. This is done, for example, in a supervised learning using training images annotated by intermediate classes. The training of a neural network for fixed classification work using example images and associated labels is known per se and will not be explained in any more detail here; some additional explanations can in turn be found in the literature cited in the introduction.

Example images are evaluated by the multiclass classifier in a step T2. Confidence values for the intermediate classes result from this for a respective example image, as at the left in FIG. 3. These example images are annotated by target classes, not intermediate classes. They are thus not those of step T1 for the training of the multiclass classifier that has already been fully trained at this stage. It is permitted here that images from step T1 are repeated in step T2, but they are at least differently annotated. As shown in FIG. 3, various intermediate classes related to shape, material, or strength can be provided, while cardboard/not cardboard are to be determined as target classes, for example. The example images are, for example, manually annotated with the associated target classes, with in particular a specified set of rules having been followed. The annotation can take place in a form such that the images are each divided into partitions associated with a respective target class. It would be possible to train a classifier directly for the target classes using the example images, but it is just this effort that should be avoided in accordance with the invention.

A plurality of association examples are present in a step T3 after running through step T2 multiple times. FIG. 3, that illustrated the application of the map from intermediate classes to target classes in connection with FIG. 2, can equally be understood as one of the association examples of the teaching in accordance with FIG. 4. A respective association example is thus equivalent to an m tuple of the confidence values to the m intermediate classes with which confidence values of n target classes are associated which can be noted, for example, as ((intermediate class_1, . . . , intermediate class_m), (target class_1), . . . (target class_n)). As already mentioned, the confidence values of the target classes can alternatively be omitted in that whether the target class is present or not is simply indicated binarily.

In a step T4, a map is now determined using an optimization process that is as compatible as possible with the association examples of step T3 or reproduces it. A map is naturally not meant by this that corresponds point-wise with the association examples and outputs any desired results for differing input values, but rather a map that optimally matches the association examples overall in selected error metrics and, for example, satisfies specifications on smoothness and other conditions. This is ultimately a function fit for which all the methods known per se are available. One possibility is to use a tool for the hyperparameter optimization (HPO) such as Optuna (Akiba, Takuya, et al. “Optuna: A next-generation hyperparameter optimization framework”, Proceedings of the 25th

ACM SIGKDD international conference on knowledge discovery & data mining, 2019.).

The optimization of any desired map in space of all the possible maps from the m-dimensional space of the intermediate classes into the n-dimensional space of the target classes means a certain effort and possibly does not converge into a useful optimum. It is therefore conceivable only to permit certain classes of maps, in particular those that first only evaluate each intermediate class per se. The map in step S4 of FIG. 2, for example, can only compare the intermediate classes with a threshold value and a conclusion is drawn on the intermediate class from the intermediate classes whose confidence value is above the threshold value. Step T4 of FIG. 4 is then correspondingly simplified to the location of optimum threshold values.

A reclassification of the original intermediate classes into new target classes thus takes place in summary by the map that is located, taught, or parameterized in step T4 of FIG. 4. The target classes can subsequently be specified by rules or by annotated example images based on the rules. The effort for locating the map in step T4 is disparately smaller than that for a training or retraining of the multiclass classifier using the target classes.

1. An image capturing device for associating a target class with an object, wherein the image capturing device has an image sensor for recording image data having the object and a control and evaluation unit that is configured to evaluate and classify the image data using a method of machine learning, and to associate a target class with the image data, wherein the control and evaluation unit is further configured to use as a method of machine learning a multiclass classifier for the classification into a plurality of intermediate classes that determines respective confidence values for the association of the image data with a respective intermediate class and subsequently to determine the target class by applying a map of confidence values in target classes.

2. The image capturing device in accordance with claim 1, wherein the method of machine learning comprises a neural network.

3. The image capturing device in accordance with claim 1, wherein none of the target classes is an intermediate class.

4. The image capturing device in accordance with claim 1, wherein the intermediate classes are defined by at least one of the following properties of the recorded object: material; strength; and shape.

5. The image capturing device in accordance with claim 4, wherein the material is one of plastic, polystyrene, wood, and metal.

6. The image capturing device in accordance with claim 4, wherein the strength is one of rigid and flexible.

7. The image capturing device in accordance with claim 4, wherein the shape is one of parallelepiped, cylinder, torus, and irregular.

8. The image capturing device in accordance with claim 1, wherein exactly two target classes are provided.

9. The image capturing device in accordance with claim 8, wherein the exactly two target classes comprise cardboard or not cardboard.

10. The image capturing device in accordance with claim 1, wherein the multiclass classifier has an attention mechanism.

11. The image capturing device in accordance with claim 1, wherein the multiclass classifier has a first stage that generates an embedding from the image data and a second stage that determines the intermediate classes from the features of the embedding.

12. The image capturing device in accordance with claim 1, wherein the map evaluates the intermediate classes individually with a threshold value.

13. The image capturing device in accordance with claim 1, wherein the map is taught in that the multiclass classifier determines confidence values for a plurality of example images annotated by a desired target class and that map is determined in an optimization that best reproduces the associated annotated target class with a predetermination of the respective confidence values found with respect to an example image.

14. The image capturing device in accordance with claim 13, wherein the map is initialized with first any desired threshold values for every intermediate class and the optimization only changes the threshold values.

15. The image capturing device in accordance with claim 1, that is installed at a conveying device on which objects to be classified are conveyed through the field of view of the image sensor.

16. The image capturing device in accordance with claim 15, wherein a plurality of camera heads are provided and the control and evaluation unit is configured to merge the recordings of the camera heads in the image data to one common image.

17. A method of associating a target class with an object, wherein image data having the object are evaluated and classified using a method of machine learning, and a target class is associated with the image data, wherein, as a method of machine learning, a multiclass classifier for the classification into a plurality of intermediate classes is used that determines respective confidence values for the association of the image data with a respective intermediate class and subsequently to determine the target class by applying a map of confidence values in target classes.

18. The method in accordance with claim 17, wherein the method of machine learning comprises a neural network.

19. The method in accordance with claim 17, wherein the map Is taught in that the multiclass classifier determines confidence values for a plurality of example images annotated by a desired target class and that map is determined in an optimization that best reproduces the associated annotated target class with a predetermination of the respective confidence values found with respect to an example image.
